(19) United States
(12) Patent Application Publication
(10) Pub. No.: US 2026/0184077 A1
(43) Pub. Date: Jul. 2, 2026

(54) LIQUID EJECTING HEAD AND LIQUID EJECTING APPARATUS

(71) Applicant: SEIKO EPSON CORPORATION, Tokyo (JP)

(72) Inventors: Yuichi KATANIWA, SHIOJIRI-SHI (JP); Noriaki OKAZAWA, SHIOJIRI-SHI (JP); Yusuke ISHII, SHIOJIRI-SHI (JP)

(21) Appl. No.: 19/428,738

(22) Filed: Dec. 22, 2025

(30) Foreign Application Priority Data
Dec. 26, 2024 (JP) 2024-230024

(51) Int. Cl. B41J 2/14; B41J 2/045; B41J 2/16

(52) U.S. Cl. CPC B41J 2/1433; B41J 2/0451; B41J 2/162; B41J 2/0458; B41J 2/04581

(57) ABSTRACT

A liquid ejecting head includes: a plurality of nozzles configured to eject liquid in an ejection direction; an ejection surface that is a surface facing the ejection direction; and a coating film provided on the ejection surface, the coating film includes a first layer having higher liquid repellency than the ejection surface and a second layer having a color different from a color of the first layer, and the second layer overlaps at least part of the first layer when viewed in a direction opposite to the ejection direction.

The present application is based on, and claims priority from JP Application Serial Number 2024-230024, filed December 26, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

JP-A-2014-193554 discloses a liquid ejecting head in which a liquid-repellent film such as a metal film containing a fluorine-based polymer is provided on an ejection surface of a nozzle plate.

The liquid-repellent film which covers the ejection surface may be gradually worn or peeled off due to contact with a wiping member, a suction member, or the like for maintenance of the liquid ejecting head. When the ejection surface is exposed due to peeling or the like of the liquid-repellent film, there is a possibility that a failure may occur in the liquid ejecting head. Hence, it is required to predict the life of the coating film such as the liquid-repellent film before the ejection surface is exposed.

### SUMMARY

To address the challenge mentioned above, a liquid ejecting head according to a preferred aspect of the present disclosure includes: a plurality of nozzles configured to eject liquid in an ejection direction; an ejection surface that is a surface facing the ejection direction; and a coating film provided on the ejection surface, the coating film includes a first layer having higher liquid repellency than the ejection surface and a second layer having a color different from a color of the first layer, and the second layer overlaps at least part of the first layer when viewed in a direction opposite to the ejection direction.

A liquid ejecting apparatus according to a preferred aspect of the present disclosure includes: the liquid ejecting head according to the aspect described above; and a detection unit that detects whether or not the second layer is exposed.

### BRIEF DESCRIPTION OF THE DRAWINGS

FIG. 1 is a schematic view illustrating a configuration example of a liquid ejecting apparatus according to a first embodiment.

FIG. 2 is an exploded perspective view of a liquid ejecting head according to the first embodiment.

FIG. 3 is a cross-sectional view of part of the liquid ejecting head according to the first embodiment.

FIG. 4 is a bottom view of the liquid ejecting head according to the first embodiment.

FIG. 5 is an explanatory view of a configuration example of a coating film in the first embodiment.

FIG. 6 is a schematic cross-sectional view of the coating film in the first embodiment.

FIG. 7 is an explanatory view of an exposed state of a second layer of the coating film.

FIG. 8 is a schematic cross-sectional view of a coating film in a second embodiment.

FIG. 9 is an explanatory view of an exposed state of a second layer of the coating film.

FIG. 10 is an explanatory view of an exposed state of a third layer of the coating film.

FIG. 11 is a schematic cross-sectional view of a coating film in a third embodiment.

FIG. 12 is a schematic cross-sectional view of a coating film in a fourth embodiment.

FIG. 13 is a schematic cross-sectional view of a coating film in a fifth embodiment.

FIG. 14 is a schematic cross-sectional view of a coating film in a sixth embodiment.

FIG. 15 is a plan view illustrating a state where a second layer is covered with a first layer in the coating film illustrated in FIG. 14.

FIG. 16 is a plan view illustrating a state in which the second layer is exposed from the first layer in the coating film illustrated in FIG. 14.

FIG. 17 is a schematic cross-sectional view of a coating film in a seventh embodiment.

FIG. 18 is a plan view illustrating a state in which a second layer remains in the coating film illustrated in FIG. 17.

FIG. 19 is a plan view of a state in which the second layer has disappeared in the coating film illustrated in FIG. 17.

FIG. 20 is a schematic view illustrating a configuration example of a liquid ejecting apparatus according to an eighth embodiment.

FIG. 21 is a bottom view of a liquid ejecting head according to the eighth embodiment.

### DESCRIPTION OF EMBODIMENTS

Hereinafter, preferred embodiments according to the present disclosure will be described with reference to the accompanying drawings. In the drawings, the dimensions and scales of each portion are different from actual ones as appropriate, and some parts are schematically illustrated for ease of understanding. In addition, the scope of the present disclosure is not limited to the following configurations unless otherwise specified in the following description as limiting the present disclosure.

For convenience, an X-axis, a Y-axis, and a Z-axis intersecting each other will be used as appropriate in the following description. Hereinafter, one direction along the X-axis will be referred to as an X1 direction, and a direction opposite to the X1 direction will be referred to as an X2 direction. Similarly, directions opposite to each other along the Y-axis are a Y1 direction and a Y2 direction. Further, directions opposite to each other along the Z-axis are a Z1 direction and a Z2 direction. The Z2 direction is an ejection direction DJ described later.

Typically, the Z-axis is a vertical axis, and the Z2 direction corresponds to a downward direction in a vertical direction. However, the Z-axis is not limited to being the vertical axis. The X-axis, the Y-axis, and the Z-axis are typically orthogonal to each other, but are not limited thereto, and need only intersect each other at an angle within a range of from, for example, 80° to 100°.

### 1. First Embodiment

### 1-1. Schematic Configuration of Liquid Ejecting Apparatus

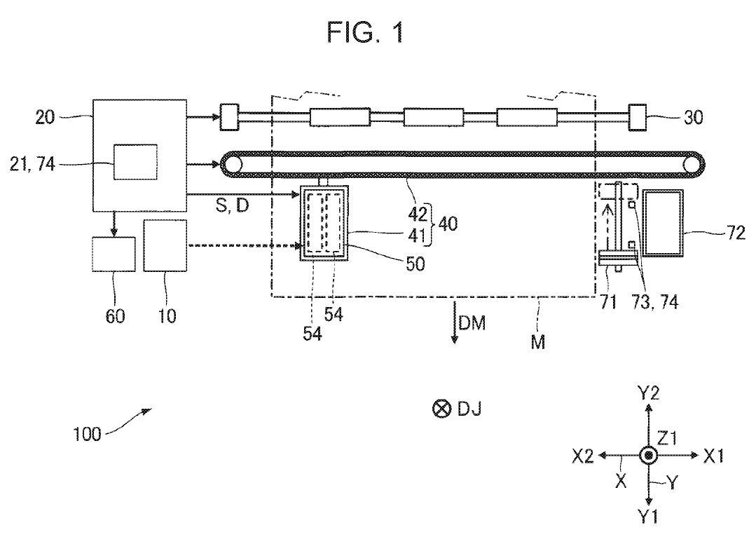

FIG. 1 is a schematic view illustrating a configuration example of a liquid ejecting apparatus 100 according to a first embodiment. The liquid ejecting apparatus 100 is an ink jet printing apparatus that ejects ink which is an example of "liquid" to a medium M as droplets. The medium M is typically a printing sheet. The medium M is not limited to a printing sheet and may be, for example, a printing target of any material such as a resin film or a cloth.

As illustrated in FIG. 1, the liquid ejecting apparatus 100 includes a liquid container 10, a control unit 20, a transport mechanism 30, a movement mechanism 40, a liquid ejecting head 50, a notification unit 60, a wiping member 71, a cap member 72, and sensors 73. Hereinafter, these will be briefly described in order with reference to FIG. 1.

The liquid container 10 stores ink. Examples of specific aspects of the liquid container 10 include a cartridge which can be attached to and detached from the liquid ejecting apparatus 100, a bag-shaped ink pack which is formed of a flexible film, and an ink tank that can be replenished with ink. The type of ink stored in the liquid container 10 is not particularly limited, and may be selected as appropriate.

The control unit 20 includes, for example, a processing circuit such as a central processing unit (CPU) or a field programmable gate array (FPGA) and a storage circuit such as a semiconductor memory, and controls the operation of each element of the liquid ejecting apparatus 100.

The transport mechanism 30 transports the medium M in a transport direction DM, which is the Y1 direction, under the control of the control unit 20. The movement mechanism 40 causes the liquid ejecting head 50 to reciprocate in the X1 direction and the X2 direction under the control of the control unit 20. In the example illustrated in FIG. 1, the movement mechanism 40 includes a substantially box-shaped transport member 41 called a carriage which houses the liquid ejecting head 50, and a transport belt 42 to which the transport member 41 is fixed. In addition to the liquid ejecting head 50, the liquid container 10 described above may be mounted on the transport member 41.

In the present embodiment, the movement mechanism 40 not only reciprocates the liquid ejecting head 50 along the X-axis over the entire width of the medium M, but also can move the liquid ejecting head 50 to a position overlapping the wiping member 71, the cap member 72, or the sensors 73 when viewed in the direction along the Z-axis.

The liquid ejecting head 50 ejects the ink supplied from the liquid container 10 onto the medium M in the ejection direction DJ from each of the plurality of nozzles under the control of the control unit 20. The ejection is performed in parallel with the transport of the medium M by the transport mechanism 30 and the reciprocating movement of the liquid ejecting head 50 by the movement mechanism 40, and thus an image is formed on the surface of the medium M with ink. As will be described in detail later, the liquid ejecting head 50 includes a plurality of head chips 54.

The notification unit 60 is a device that presents various kinds of information under the control of the control unit 20. Specifically, the notification unit 60 is, for example, a display device including a display panel of various types such as a liquid crystal display panel and an organic electro-luminescence (EL) display panel. In the present embodiment, the notification unit 60 presents information related to a replacement time, a maintenance time, and the like of the liquid ejecting head 50.

The notification unit 60 is not limited to a configuration that performs notification on a display device, and may have, for example, a configuration that performs notification by lighting, blinking, or the like of a light emitting element such as a light emitting diode (LED), a configuration that performs notification with sound, or other configurations.

The wiping member 71 is a member for wiping an ejection surface F, which will be described later, of the liquid ejecting head 50. In the example illustrated in FIG. 1, the wiping member 71 is an elastic member such as a blade-shaped rubber member formed of an elastic material such as rubber, having an elongated shape extending in the direction along the X-axis, and protruding in the Z1 direction, and reciprocates in the direction along the Y-axis being driven by a movement mechanism such as an actuator (not illustrated). The wiping member 71 is disposed at a position away from the transport region of the medium M in the direction along the X-axis. When the wiping member 71 wipes the ejection surface F, the movement mechanism 40 places the liquid ejecting head 50 at a position overlapping the movement range of the wiping member 71 when viewed in the direction along the Z-axis. This enables the wiping member 71 to wipe the ejection surface F.

Here, the length of the wiping member 71 in the direction along the X-axis is approximately equal to or slightly longer than the width, in the direction along the X-axis, of the set of two head chips 54 adjacent to each other in the direction along the X-axis. The wiping member 71 is not limited to the example illustrated in FIG. 1, and for example, may have a configuration including two or more blade-shaped elastic members, or may have a configuration including a fiber material such as a woven fabric or a non-woven fabric, or a porous member such as a sponge. The wiping member 71 is provided as necessary and may be omitted.

The cap member 72 is a lid member having a recessed portion for capping all the nozzles N of the liquid ejecting head 50. To be specific, although not illustrated, the cap member 72 includes, for example, a main body portion having a recessed shape made of a resin or the like, and an annular edge portion provided at a distal end portion of the main body portion in the Z1 direction and made of an elastic material such as a rubber material or an elastomer material. The cap member 72 is reciprocated in the direction along the Z-axis by a movement mechanism such as an actuator (not illustrated). Then, the cap member 72 forms a closed space between the cap member 72 and the ejection surface F by the edge portion coming into contact with the ejection surface F described later. Accordingly, it is possible to prevent moisture from evaporating from the ink in the nozzles N and thickening of the ink. In addition, the cap member 72 is disposed at a position away from the transport region of the medium M in the direction along the X-axis. When the capping is performed by the cap member 72, the movement mechanism 40 places the liquid ejecting head 50 at a position overlapping the cap member 72 when viewed in the direction along the Z-axis. Thus, the ejection surface F can be capped by the cap member 72.

A suction port connected to a pressure reducing mechanism such as a vacuum pump may be provided at the bottom surface of the recessed portion of the cap member 72. In this case, the nozzles N can be suction-cleaned by the negative pressure generated by the pressure reducing mechanism. In this way, the cap member 72 may be used as a suction member for performing suction on the nozzles N. The cap member 72 is provided as necessary and may be omitted.

The sensors 73 are sensors that detect changes in color of a coating film 80 described later. Specifically, the sensors 73 are, for example, optical sensors that detect the intensity or the like of light reflected by the coating film 80 described later. The control unit 20 has a function as a determination unit 21 which determines whether a second layer 81b which will be described later is exposed based on the detection results of the sensors 73. In a case where the determination unit 21 determines that a second layer 81b is exposed, the control unit 20 causes the notification unit 60 to indicates that a second layer 81b is exposed, that the coating film 80 is nearing the end of its life, or that it is time to replace the liquid ejecting head 50.

Here, the sensors 73 and the determination unit 21 compose a detection unit 74 that detects whether or not a second layer 81b is exposed. Thereby, whether a second layer 81b is exposed can be checked by the detection unit 74. Therefore, the labor for visual checking can be omitted. In addition, the detection accuracy is high because the color difference detection capability or resolution is higher than visual checking. Therefore, the degrees of freedom of the colors of first layers 81a and second layers 81b can be increased, and the size of the indicator or text can be small.

In the present embodiment, the sensors 73 are two sensors arranged in the direction along the Y-axis so as to correspond to the arrangement of the second layers 81b described later.

### 1-2. Liquid Ejecting Head

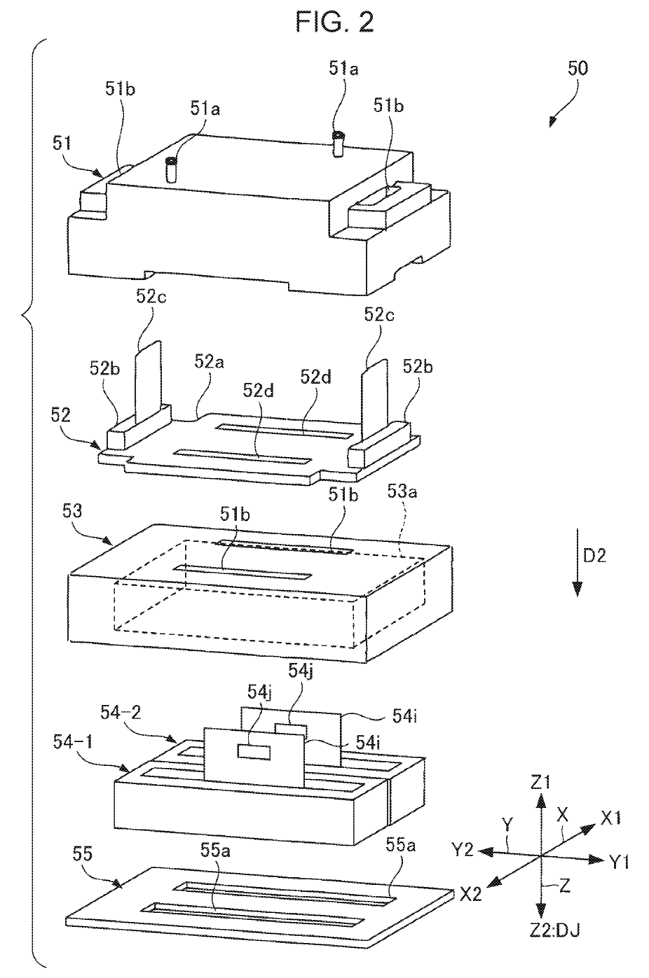

FIG. 2 is an exploded perspective view of the liquid ejecting head 50 according to the first embodiment. As illustrated in FIG. 2, the liquid ejecting head 50 includes a flow path structure 51, a substrate unit 52, a holder 53, two head chips 54-1 and 54-2, and a fixing plate 55. The head chips 54-1 and 54-2 are the head chips 54 illustrated in FIG. 1. Hereinafter, when the head chips 54-1 and 54-2 are not distinguished from each other, each of the head chips 54-1 and 54-2 is referred to as the head chip 54.

The flow path structure 51, the substrate unit 52, the holder 53, the head chips 54-1 and 54-2, and the fixing plate 55 are stacked in this order in the Z2 direction. These are appropriately joined to each other through screwing, an adhesive, or the like. Hereinafter, each portion of the liquid ejecting head 50 will be described in order.

The flow path structure 51 is a structure in which one or more flow paths for supplying the ink stored in the liquid container 10 described above to the two head chips 54 are provided. While illustration is not provided, the flow path structure 51 is a multilayer body including a plurality of substrates stacked in the direction along the Z-axis. Each of the plurality of substrates is appropriately provided with a groove and a hole for the flow paths, a filter chamber having a filter for capturing foreign matter contained in the ink, and the like. The plurality of substrates are joined to each other through, for example, an adhesive, brazing, welding, or screwing. A sheet-shaped sealing member made of a rubber material or the like may be appropriately disposed between the plurality of substrates, as necessary. The number, thickness, or the like of the substrates constituting the flow path structure 51 is determined in accordance with the configuration such as the shape of the supply flow path, is not particularly limited, and may be appropriately selected. Each of the plurality of substrates is not particularly limited and is made of, for example, metal, ceramic, or a resin composition.

Although not illustrated, two supply flow paths for supplying ink to the head chips 54 are provided in the flow path structure 51. Each of the two supply flow paths includes one inlet for receiving supply of ink and one discharge port for discharging ink. The inlet of each supply flow path is provided on a surface of the flow path structure 51 facing the Z1 direction. The discharge port of each supply flow path is provided on a surface of the flow path structure 51 facing the Z2 direction.

A plurality of coupling pipes 51a are provided on a surface of the flow path structure 51 facing the Z1 direction. Each of the plurality of coupling pipes 51a is a pipe that protrudes from the surface of the flow path structure 51 facing the Z1 direction. In the example illustrated in FIG. 2, two coupling pipes 51a corresponding to the two supply flow paths mentioned above are provided in the flow path structure 51, and each coupling pipe 51a is coupled to the inlet of the corresponding supply flow path. Separate ink tubes are connected to the two coupling pipes 51a so as to be supplied with different types of ink, and the two coupling pipes 51a are connected to the liquid container 10 via the ink tubes.

The flow path structure 51 is provided with a plurality of wiring holes 51b through which wiring members 52c (described later) of the substrate unit 52 pass. The flow path structure 51 is provided with a hole (not illustrated) and is fixed to the holder 53 by screwing through the hole.

The substrate unit 52 is an assembly including a mounted component for electrically coupling the liquid ejecting head 50 to the control unit 20. The substrate unit 52 includes a circuit substrate 52a, connectors 52b, and the wiring members 52c.

The circuit substrate 52a is a printed wiring substrate such as a rigid wiring substrate including a wiring pattern for electrically coupling each head chip 54 to the corresponding connector 52b. The circuit substrate 52a is disposed between the flow path structure 51 and the holder 53, and the connectors 52b are disposed on a surface of the circuit substrate 52a facing the Z1 direction. The circuit substrate 52a is provided with a plurality of wiring holes 52d through which wiring substrates 54i of the head chips 54 pass. Accordingly, the wiring substrates 54i are coupled to the surface of the circuit substrate 52a facing the Z1 direction through the wiring holes 52d.

The connectors 52b are coupling components electrically coupled to the circuit substrate 52a. The wiring members 52c are coupled to the connectors 52b. Each wiring member 52c is a flexible wiring substrate such as a chip on film (COF), a flexible printed circuit (FPC), or a flexible flat cable (FFC) for electrically coupling the corresponding connector 52b to the control unit 20. The circuit substrate 52a is fixed to the flow path structure 51 or the holder 53 by screwing or the like.

The holder 53 is a structure housing and supporting the plurality of head chips 54. The holder 53 is made of, for example, metal, ceramic, or a resin composition. The holder 53 is provided with a recessed portion 53a and a plurality of wiring holes 53b. The recessed portion 53a is a space open in the Z2 direction, in which the plurality of head chips 54 are disposed. Each of the plurality of wiring holes 53b is a hole through which the wiring substrate 54i of the corresponding head chip 54 passes toward the substrate unit 52. The recessed portion 53a may be divided into a plurality of recessed portions corresponding to the respective head chips 54.

While illustration is not provided, the holder 53 includes one or more flow paths for providing ink to the two head chips 54 and thus also functions as a flow path structure. Accordingly, the supply flow paths of the flow path structure 51 are coupled to the head chips 54 through the flow paths of the holder 53. The holder 53 mentioned above may be configured as, for example, a multilayer body obtained by stacking a plurality of substrates in the direction along the Z-axis, like the flow path structure 51. The flow paths of the holder 53 are provided as necessary and may be omitted. In this case, the supply flow paths of the flow path structure 51 are coupled to the head chips 54 without passing through the flow paths of the holder 53.

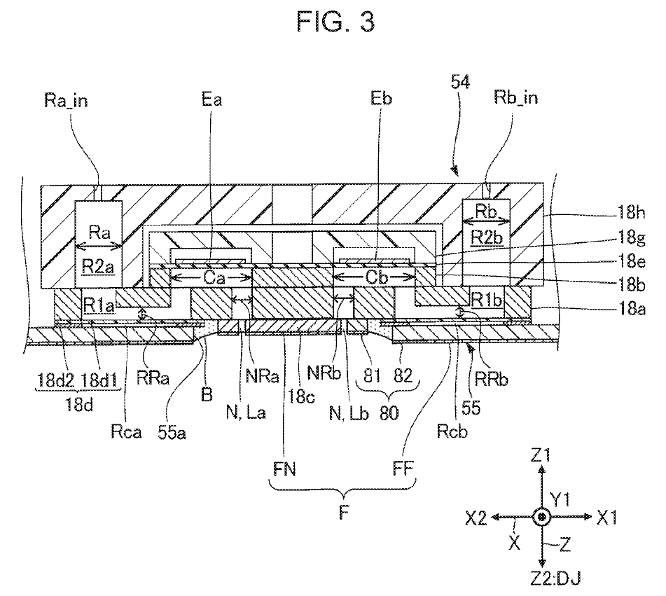

Each head chip 54 ejects ink. Each head chip 54 is provided with the wiring substrate 54i. FIG. 2 schematically illustrates the configuration of each head chip 54. Details of the head chip 54 will be described later with reference to FIG. 3.

The fixing plate 55 is a plate-shaped member to which the two head chips 54 and the holder 53 are fixed, and has openings 55a-1 and 55a-2 and a surface FF. The opening 55a-1 exposes the plurality of nozzles N of the head chip 54-1 to the outside. The opening 55a-2 exposes the plurality of nozzles N of the head chip 54-2 to the outside. The surface FF is part of the ejection surface F described later. The fixing plate 55 is disposed in a state where the two head chips 54 are held between the fixing plate 55 and the holder 53, and each head chip 54 and the holder 53 are fixed with an adhesive or the like. The head chips 54-1 and 54-2 are fixed to the fixing plate 55 as mentioned above. Hereinafter, each of the openings 55a-1 and 55a-2 may be referred to as an opening 55a without distinction.

For example, the fixing plate 55 is made of a metal material or the like such as stainless steel, titanium, and a magnesium alloy.

FIG. 3 is a cross-sectional view of part of the liquid ejecting head 50 according to the first embodiment. As illustrated in FIG. 3, the head chip 54 is provided with a plurality of nozzles N that eject ink. The plurality of nozzles N are divided into a nozzle row La and a nozzle row Lb. Each of the nozzle row La and the nozzle row Lb is a set of nozzles N arranged along the Y-axis. The nozzle row La and the nozzle row Lb are spaced from each other in the X-axis direction.

The head chip 54 includes a liquid storage chamber Ra, a plurality of pressure chambers Ca, and a plurality of driving elements Ea, as components corresponding to the nozzle row La. The liquid storage chamber Ra is a common liquid chamber which is continuous over the plurality of nozzles N of the nozzle row La. Ink is introduced into the liquid storage chamber Ra via an inlet Ra_in. One pressure chamber Ca and one driving element Ea are provided for each nozzle N of the nozzle row La. Each pressure chamber Ca is a space communicating with the corresponding nozzle N. Each of the plurality of pressure chambers Ca is filled with ink supplied from the liquid storage chamber Ra. The driving element Ea changes the pressure of the ink in the pressure chamber Ca. The driving element Ea is, for example, a piezoelectric element which changes the capacity of the pressure chamber Ca by deforming a wall surface of the pressure chamber Ca, or a heating element which generates an air bubble in the pressure chamber Ca by heating the ink in the pressure chamber Ca. When the driving element Ea changes the pressure of the ink in the pressure chamber Ca, the ink in the pressure chamber Ca is ejected from the nozzle N.

In addition, the head chip 54 includes a liquid storage chamber Rb, a plurality of pressure chambers Cb, and a plurality of driving elements Eb, as components corresponding to the nozzle row Lb. The liquid storage chamber Rb is a common liquid chamber which is continuous over the plurality of nozzles N of the nozzle row Lb. Ink is introduced into the liquid storage chamber Rb via an inlet Rb_in. One pressure chamber Cb and one driving element Eb are provided for each nozzle N of the nozzle row Lb. Each of the plurality of pressure chambers Cb is filled with ink supplied from the liquid storage chamber Rb. The driving element Eb is, for example, the piezoelectric element or the heating element described above. When the driving element Eb changes the pressure of the ink in the pressure chamber Cb, the ink in the pressure chamber Cb is ejected from the nozzle N.

As illustrated in FIG. 3, the head chip 54 includes a communication plate 18a, a pressure-chamber substrate 18b, a nozzle plate 18c, a compliance substrate 18d, a diaphragm 18e, the plurality of driving elements Ea and Eb, a cover 18g, and a case 18h.

The communication plate 18a and the pressure-chamber substrate 18b are stacked in this order in the Z1 direction, and form flow paths for supplying ink to the plurality of nozzles N. The diaphragm 18e, the plurality of driving elements Ea and Eb, the cover 18g, the case 18h, a wiring substrate 18i, and a drive circuit 18j are provided in a region positioned in the Z1 direction relative to the multilayer body including the communication plate 18a and the pressure-chamber substrate 18b. In a region positioned in the Z2 direction relative to the multilayer body, the nozzle plate 18c and the compliance substrate 18d are provided. Each element of the head chip 54 is approximately a plate-shaped member elongated in the Y direction, and is bonded to another element, for example, with an adhesive or by direct bonding.

The nozzle plate 18c is a plate-shaped member which is stacked on the communication plate 18a and has the plurality of nozzles N of each of the nozzle row La and the nozzle row Lb. Each of the plurality of nozzles N is a through hole through which ink passes, and ejects the ink in the Z2 direction which is the ejection direction DJ. Here, the thickness direction of the nozzle plate 18c is the direction along the Z-axis. The surface of the nozzle plate 18c facing the Z2 direction serves as a nozzle surface FN. The nozzle plate 18c is manufactured in such a manner that a silicon single crystal substrate is processed by a semiconductor manufacturing technique using a processing technique such as dry etching or wet etching, for example. However, other known methods and materials may be appropriately used for manufacturing the nozzle plate 18c. The cross-sectional shape of each nozzle is typically a circular shape but is not limited thereto, and may be a non-circular shape such as a polygonal shape or an elliptical shape, for example. Here, the nozzle plate 18c is bonded to a surface of the communication plate 18a that faces the Z2 direction with an adhesive or the like. As described above, the liquid ejecting head 50 includes the nozzle plates 18c each having the plurality of nozzles N.

In the communication plate 18a, spaces R1a and R1b, a plurality of supply flow paths RRa and RRb, and a plurality of communication flow paths NRa and NRb are provided for the nozzle row La and the nozzle row Lb, as flow paths communicating with the nozzles N. Each of the spaces R1a and R1b is an elongated opening extending in the direction along the Y-axis in a plan view in the direction along the Z-axis. Each of the supply flow paths RRa and RRb and each of the communication flow paths NRa and NRb are through holes formed for each nozzle N. Each supply flow path RRa communicates with the space R1a. Each supply flow path RRb communicates with the space R1b.

The nozzle plate 18c and the compliance substrate 18d are stacked on the surface of the communication plate 18a facing the Z2 direction, and the foregoing spaces R1a and R1b and the foregoing communication flow paths NRa and NRb are open in the same surface of the communication plate 18a.

The pressure-chamber substrate 18b is a plate-shaped member in which the plurality of pressure chambers Ca and the plurality of pressure chambers Cb are provided. The plurality of pressure chambers Ca are arranged in the direction along the Y-axis. Similarly, the plurality of pressure chambers Cb are arranged in the direction along the Y-axis. Each pressure chamber Ca is formed for each nozzle N of the nozzle row La, and is an elongated space extending in the direction along the X-axis in a plan view. Similarly, each pressure chamber Cb is formed for each nozzle N of the nozzle row Lb, and is an elongated space extending in the direction along the X-axis in a plan view. Similar to the nozzle plate 18c described above, each of the communication plate 18a and the pressure-chamber substrate 18b is manufactured, for example, by processing a silicon single crystal substrate by a semiconductor-manufacturing technique. However, other known methods and materials may be appropriately used for manufacturing each of the communication plate 18a and the pressure-chamber substrate 18b.

The pressure chamber Ca communicates with each of the communication flow path NRa and the supply flow path RRa. Therefore, the pressure chamber Ca communicates with the nozzle N of the nozzle row La via the communication flow path NRa, and communicates with the space R1a via the supply flow path RRa. Similarly, the pressure chamber Cb communicates with each of the communication flow path NRb and the supply flow path RRb. Therefore, the pressure chamber Cb communicates with the nozzle N of the nozzle row Lb via the communication flow path NRb, and communicates with the space R1b via the supply flow path RRb.

The diaphragm 18e is disposed on the surface of the pressure-chamber substrate 18b facing the Z1 direction. The diaphragm 18e is a plate-shaped member that can elastically vibrate. The diaphragm 18e has, for example, a first layer and a second layer, and the first layer and the second layer are stacked together in this order in the Z1 direction. The first layer is, for example, an elastic film made of a silicon oxide (SiO₂). For example, the elastic film is formed by thermally oxidizing one surface of a silicon single crystal substrate. The second layer is, for example, an insulating film made of a zirconium oxide (ZrO₂). The insulating film is formed, for example, by forming a zirconium layer by a sputtering method and then thermally oxidizing the layer. Note that the diaphragm 18e is not limited to the configuration obtained by stacking the first layer and the second layer and, for example, may be formed of a single layer or three or more layers.

The plurality of driving elements Ea and the plurality of driving elements Eb are disposed on the surface of the diaphragm 18e facing the Z1 direction. Each of the driving elements Ea and Eb is a passive element that is deformed by receiving driving signals. Each of the driving elements Ea and Eb has an elongated shape extending in the direction along the X-axis in a plan view. The plurality of driving elements Ea are arranged in the direction along the Y-axis so as to correspond to the plurality of pressure chambers Ca. Each driving element Ea overlaps the corresponding pressure chamber Ca in a plan view. Similarly, the plurality of driving elements Eb are arranged in the direction along the Y-axis so as to correspond to the plurality of pressure chambers Cb. Each driving element Eb overlaps the corresponding pressure chamber Cb in a plan view.

Although not illustrated, each of the driving elements Ea and Eb includes a first electrode, a piezoelectric layer, and a second electrode, which are stacked in this order in the Z1 direction. One electrode of the first electrode and the second electrode is an individual electrode arranged for each driving element Ea or each driving element Eb so as to be spaced from the other individual electrodes, and a driving signal is applied to the one electrode. The other electrode of the first electrode and the second electrode is a strip-shaped common electrode extending in the direction along the Y-axis so as to be continuous over the plurality of driving elements Ea or the plurality of driving elements Eb, and a predetermined reference potential is supplied to the other electrode. Examples of the metal material of these electrodes include metal materials such as platinum (Pt), aluminum (Al), nickel (Ni), gold (Au), and copper (Cu), and among these materials, one kind may be used alone, or two or more kinds may be used in combination in the form of an alloy or a stacking structure. The piezoelectric layer is formed of a piezoelectric material such as lead zirconate titanate (Pb(Zr,Ti)O₃₎, and has, for example, a strip shape extending in the direction along the Y-axis so as to be continuous over the plurality of driving elements Ea or the plurality of driving elements Eb. However, the piezoelectric layer may be individually provided for each driving element Ea or each driving element Eb. When the diaphragm 18e vibrates in conjunction with the deformation of the driving elements Ea mentioned above, the pressures in the pressure chambers Ca change, and ink is thereby ejected from the nozzles N of the nozzle row La. Similarly, when the diaphragm 18e vibrates in conjunction with the deformation of the driving elements Eb, the pressures in the pressure chambers Cb change, and ink is thereby ejected from the nozzles N of the nozzle row Lb. Note that the driving elements may be heating elements which heat the ink in the pressure chambers Ca and Cb, instead of the driving elements Ea and Eb.

The cover 18g is a plate-shaped member located on the surface of the diaphragm 18e facing the Z1 direction, protects the plurality of driving elements Ea and the plurality of driving elements Eb, and reinforces the mechanical strength of the diaphragm 18e. Here, the plurality of driving elements Ea and the plurality of driving elements Eb are housed between the cover 18g and the diaphragm 18e. For example, the cover 18g is formed of a resin material.

The case 18h is a case for storing ink to be supplied to the plurality of pressure chambers Ca and the plurality of pressure chambers Cb. The case 18h is made of, for example, a resin material. Spaces R2a and R2b and the inlets Ra_in and Rb_in are provided in the case 18h. The space R2a is a space that communicates with the space R1a described above, and functions, together with the space R1a, as the liquid storage chamber Ra which is a reservoir for storing ink to be supplied to the plurality of pressure chambers Ca. The ink in the liquid storage chamber Ra is supplied to each pressure chamber Ca via the corresponding supply flow path RRa. Similarly, the space R2b is a space that communicates with the space R1b described above, and functions, together with the space R1b, as the liquid storage chamber Rb which is a reservoir for storing ink to be supplied to the plurality of pressure chambers Cb. The ink in the liquid storage chamber Rb is supplied to each pressure chamber Cb via the corresponding supply flow path RRb.

The compliance substrate 18d is a substrate that absorbs fluctuations in the pressures of the ink in the liquid storage chambers Ra and Rb. The compliance substrate 18d is stacked on the communication plate 18a at positions different from the nozzle plate 18c. That is, the compliance substrate 18d and the nozzle plate 18c are stacked on the surface of the communication plate 18a facing the Z2 direction so as not to overlap each other.

The compliance substrate 18d includes a compliance film 18d1 and a frame 18d2. The compliance film 18d1 is a flexible resin film that serves as wall surfaces of the liquid storage chambers Ra and Rb. The surface of the compliance film 18d1 facing the Z1 direction is bonded to the communication plate 18a with an adhesive such as an epoxy-based adhesive. The frame 18d2 is bonded to the surface of the compliance film 18d1 facing the Z2 direction with an adhesive such as a urethane-based adhesive or an epoxy-based adhesive. The frame 18d2 is a frame-shaped member for forming compliance spaces Rca and Rcb. The frame 18d2 is made of, for example, a metal material such as stainless steel, aluminum, titanium, and a magnesium alloy. The compliance substrate 18d may be a thin metal plate having flexibility.

The surface of the frame 18d2 facing the Z2 direction is bonded to the fixing plate 55 mentioned above with an adhesive such as an epoxy-based adhesive. Here, the compliance spaces Rca and Rcb partitioned by the frame 18d2 are formed between the compliance film 18d1 and the fixing plate 55. The compliance space Rca is a space that is separated from the liquid storage chamber Ra by the compliance film 18d1 and allows the compliance film 18d1 to be deformed according to changes in the pressure of the ink in the liquid storage chamber Ra. The compliance space Rcb is a space that is separated from the liquid storage chamber Rb by the compliance film 18d1 and allows the compliance film 18d1 to be deformed according to changes in the pressure of the ink in the liquid storage chamber Rb.

Here, the surface FF facing the Z2 direction of the fixing plate 55 and the nozzle surfaces FN described above constitute the ejection surface F facing the ejection direction DJ. As described above, the nozzle plates 18c include at least part of the ejection surface F.

In a configuration without the fixing plate 55, the ejection surface F is the surfaces of the nozzle plates 18c facing the ejection direction DJ, and in a configuration including the fixing plate 55 as in the present embodiment, the ejection surface F is a surface formed by the nozzle surfaces FN which are the surfaces of the nozzle plates 18c facing the ejection direction DJ and the surface FF of the fixing plate 55 facing the ejection direction DJ. The ejection surface F mentioned above is wiped by the wiping member 71 or is brought into contact with the cap member 72 for performing suctioning on the nozzles. Coating films 81 and a coating film 82 may be one continuous film.

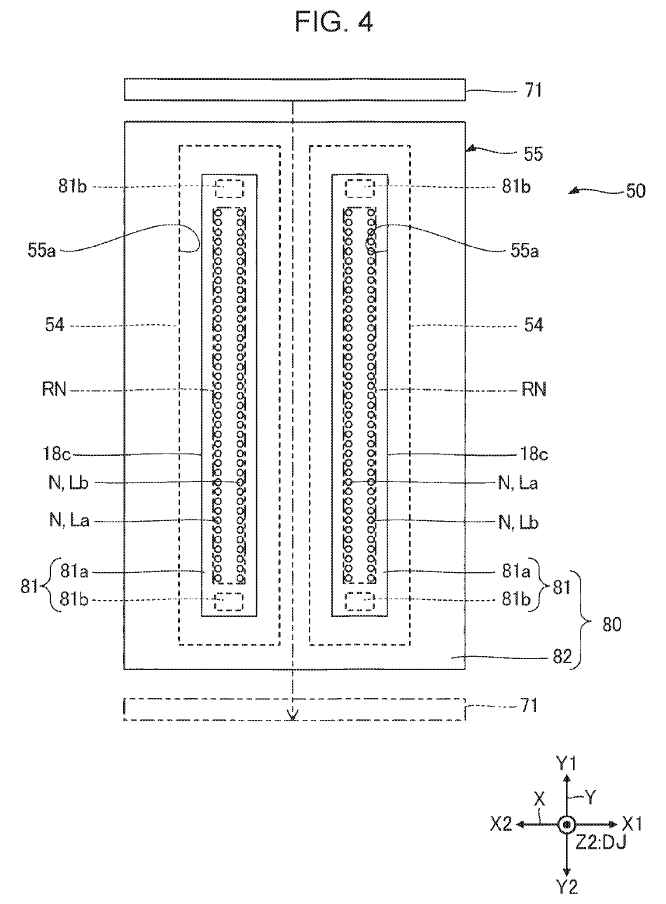

The coating film 80 is provided on the ejection surface F. The coating film 80 is divided into the coating films 81 provided on the nozzle surfaces FN and the coating film 82 provided on the surface FF. As described above, the liquid ejecting head 50 includes the ejection surface F and the coating film 80. Details of the coating film 80 will be described later with reference to FIGS. 4 to 8.

In addition, the gap between the inner peripheral surface of each opening 55a of the fixing plate 55 and the outer peripheral surface of the corresponding nozzle plate 18c is filled with a sealing material B formed of an epoxy-based adhesive, a silicone-based adhesive, or the like.

Although not illustrated in FIG. 3, the above-described wiring substrate 54i for electrically connecting the control unit 20 and the head chip 54 is mounted on the surface of the diaphragm 18e facing the Z1 direction. The wiring substrate 54i is, for example, a substrate such as a chip on film (COF), a flexible printed circuit (FPC), or a flexible flat cable (FFC), and a drive circuit 54j for supplying a drive voltage to each of the driving elements Ea and Eb is mounted on the wiring substrate 54i. The drive circuit 54j is a circuit that switches whether or not to supply at least part of a waveform included in a driving signal D as a drive pulse, based on a control signal S.

### 1-3. Coating Film

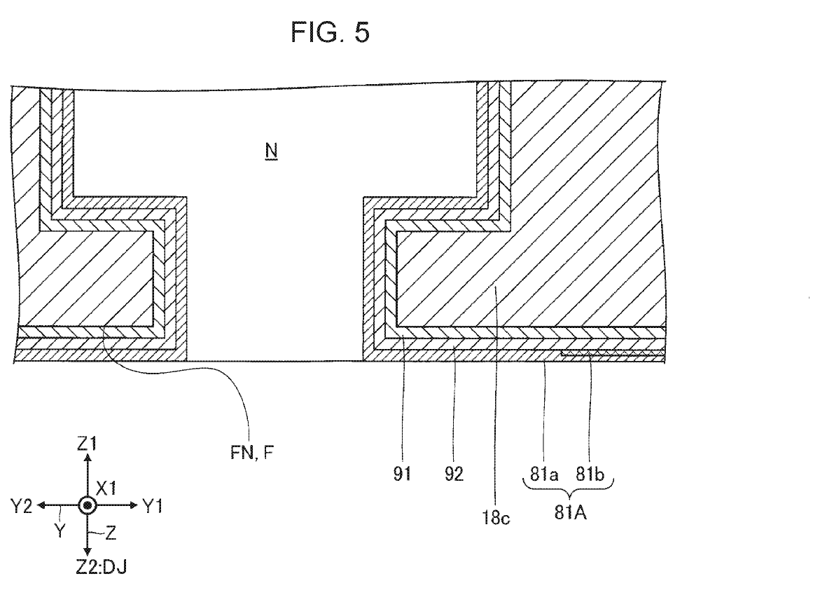

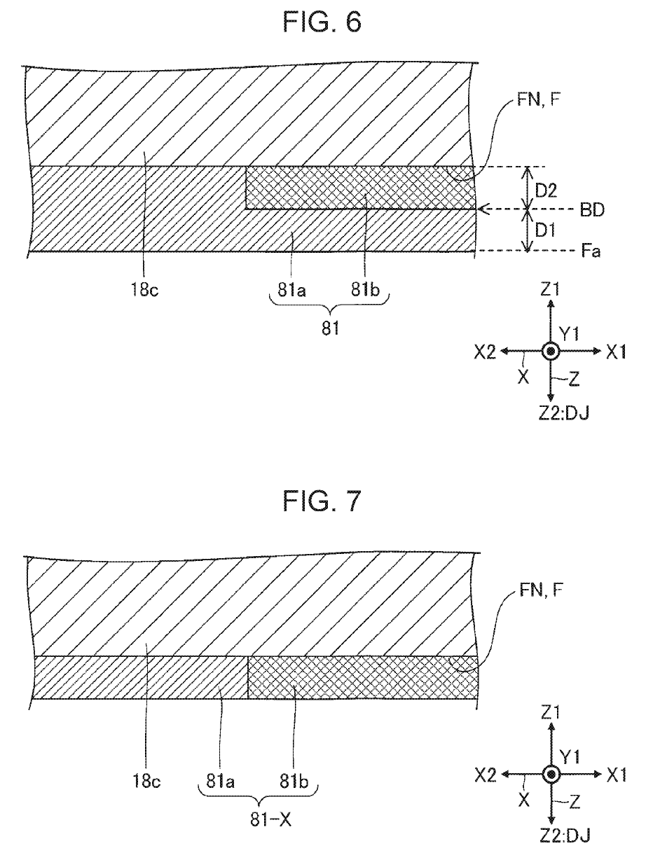

FIG. 4 is a bottom view of the liquid ejecting head 50 according to the first embodiment. FIG. 5 is a cross-sectional view of the coating film 81 in the first embodiment. FIG. 6 is a schematic cross-sectional view of the coating film 81 in the first embodiment. As illustrated in FIG. 5, a protection layer 91 and a plasma polymerized layer 92 are provided between the surface of the nozzle plate 18c and the coating film 81. In addition, the first layer 81a is provided over the entire surface of the nozzle plate 18c. That is, the first layer 81a is provided not only on the nozzle surface FN of the nozzle plate 18c but also over the entire region of the surfaces (the surfaces including the inner peripheral surface of each nozzle N) other than the nozzle surface FN of the nozzle plate 18c.

The protection layer 91 is provided on the surfaces of the nozzle plate 18c, is a layer for protecting the nozzle plate 18c from ink, and is formed of, for example, tantalum oxide. The protection layer 91 is formed by, for example, an atomic layer deposition method. The constituent material of the protection layer 91 is not limited to tantalum oxide, and may be, for example, an oxide or nitride of at least one element selected from tantalum, titanium, zirconium, niobium, vanadium, hafnium, silicon, aluminum, tungsten, and yttrium. The protection layer 91 is provided as necessary and may be omitted.

The plasma polymerized layer 92 is a layer which is provided on the protection layer 91 and increases adhesion between the coating film 81 and the nozzle plate 18c, and is formed, for example, by plasma polymerization of a silicon material. With the plasma polymerized layer 92 mentioned above, when the coating film 81 is formed using a silane-coupling agent, the adhesion between the coating film 81 and the nozzle plate 18c can be increased. The plasma polymerized layer 92 is provided as necessary and may be omitted. In FIGS. 6 to 14 and 17, the protection layer 91 and the plasma polymerized layer 92 described above are not illustrated.

As described above, the coating film 80 provided on the ejection surface F may be scraped off by receiving an external force due to contact with the wiping member 71, the suction member (the cap member 72), or the medium M in some cases. When all of the coating film 80 is scraped off, there is a possibility that a failure may occur in the liquid ejecting head 50. For example, in the case where the coating film 80 is a liquid-repellent film, when the entire liquid-repellent film is scraped off, the liquid repellency in the vicinity of the nozzles is lost, and flight deviation of the ink ejected from the nozzles or a color mixture occurs. In addition, when ink droplets are attached to the surfaces of the nozzle plates 18c or the fixing plate 55 facing the ejection direction DJ, the ink droplets are transferred to the medium.

To address the situation mentioned above, as illustrated in FIGS. 4 to 6, the coating film 80 includes the first layers 81a and the second layers 81b. Here, each second layer 81b is positioned between a first layer 81a and the ejection surface F. That is, each second layer 81b overlaps at least part of a first layer 81a when viewed in the Z1 direction which is the direction opposite to the ejection direction DJ. Further, the first layer 81a and the second layer 81b are in contact with each other. Therefore, the coating film 80 has a boundary surface BD between the first layer 81a and the second layer 81b. The boundary surface BD is a surface, of the boundary surfaces between the first layer 81a and the second layer 81b, that is substantially parallel to the ejection surface F and located farthest in the ejection direction DJ. It is preferable that each second layer 81b is provided in at least a region that is wiped by the wiping member 71 or a region that comes into contact with the cap member 72, in the ejection surface F.

As will be described in detail later, the colors of the first layers 81a and the second layers 81b are different from each other. Thereby, when the coating film 81 is scraped to the boundary surface BD between a first layer 81a and a second layer 81b, the second layer 81b becomes visible in the scraped portion. Therefore, it is possible to detect that the coating film 81 has been scraped to the boundary surface BD between the first layer 81a and the second layer 81b. Hereinafter, details of the first layers 81a and the second layers 81b will be described in order.

The first layers 81a are layers having higher liquid repellency than the ejection surface F. The term "liquid repellency" means water repellency when the main component of the liquid is water, and oil repellency when the main component of the liquid is oil, and preferably means that the static contact angle of the liquid is 90 degrees or more.

The constituent material of the first layers 81a is not particularly limited as long as it is a material having liquid repellency. Examples thereof include silane coupling agents having a fluorine-containing long-chain polymer group such as a perfluoroalkyl chain or a perfluoropolyether chain, and fluorine-based resins such as polytetrafluoroethylene (PTFE). However, as described later, the first layers 81a contain a coloring agent as necessary. Alternatively, the first layers 81a formed of a silane-coupling agent are provided with color characteristics by introducing a substituent having light absorption or fluorescence, as necessary.

The second layers 81b are layers having a color different from the color of the first layers 81a. The term "different colors" means that a difference in at least one parameter out of hue, brightness, and saturation can be recognized visually or by using a detector such as a colorimeter in a state where the liquid ejecting head 50 is irradiated with visible light.

To be more specific, the color difference between the color of the first layers 81a and the color of the second layers 81b is preferably 12.0 or more, more preferably 25 or more. Accordingly, it is possible to easily visually recognize the difference between the color of the first layers 81a and the color of the second layers 81b. The color difference mentioned above is, for example, based on the CIE 1976 L*a*B* color space. The measurement of the color difference is performed in accordance with JIS Z8730, for example.

The colors of the first layers 81a and the second layers 81b may be chromatic colors or may be achromatic colors. Chromatic colors refer to the colors having all of hue, saturation, and brightness. Specific examples of chromatic colors are not particularly limited and include, for example, JIS safety colors (red, yellowish red, yellow, green, blue, and reddish purple). Achromatic colors refer to the colors that lack both hue and saturation. Specific examples of achromatic colors are not particularly limited and include, for example, contrasting colors (white and black) of JIS safety colors.

However, when the color of one of the set of first layers 81a and the set of second layers 81b is a chromatic color and the color of the other is an achromatic color, the chromatic color is conspicuous while the achromatic color is inconspicuous, and thus the color of the first layers 81a and the color of the second layers 81b are easily distinguished from each other. From the viewpoint that the presence or absence of the exposure of the second layers 81b is easily detected when the color of the second layers 81b is more conspicuous than the color of the first layers 81a in a state where the second layers 81b are exposed, the color of the second layers 81b is preferably a chromatic color and the color of the first layers 81a is preferably an achromatic color.

The constituent material of the second layers 81b is not particularly limited as long as the colors of the first layers 81a and the second layers 81b are different from each other, but it is preferable to use a material having liquid repellency, as in the case of the first layers 81a. That is, the second layers 81b preferably have higher liquid repellency than the ejection surface F. Accordingly, even when a coating film 81 is scraped to the boundary between the first layer 81a and a second layer 81b, it is possible to prevent the liquid from being attached to the second layer 81b in a state where the second layer 81b is exposed. When the second layers 81b have liquid repellency, it may be difficult to form the first layers 81a on the second layers 81b. In such a case, the first layers 81a can be firmly bonded by forming an SiO₂ film on the surface of each second layer 81b and then forming the first layers 81a on the SiO₂ film. Thus, the first layers 81a and the second layers 81b can be stacked together. When the second layers 81b are formed, thin films can be formed by vacuum deposition or ink jet deposition. In the case of forming films by vacuum deposition, a metal may be used as the constituent material of the second layers 81b.

One or both of the constituent material of the first layers 81a and the constituent material of the second layers 81b contain a coloring agent as necessary. When at least one of the set of first layers 81a and the set of second layers 81b contains a coloring agent, the difference in color between the first layers 81a and the second layers 81b can be easily adjusted by adjusting the type, the presence or absence, the content, or the like of the coloring agent. In order to adjust the difference in color between the first layers 81a and the second layers 81b, the coloring agent is not necessarily used, and the difference in color may be adjusted by changing the reflectivity, the transmissivity, or the hue by adjusting the chemical composition or the state.

The coloring agent is not particularly limited, and examples thereof include various pigments and various dyes.

Examples of pigments include C.I. Pigment Red 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, and 108:1; C.I. Pigment Green 7, 36, 15, 17, 18, 19, 26, and 50; C.I. Pigment Blue 1, 15, 15:1, 15:2, 15:3, 15:4, 15:6, 17:1, 18, 60, 27, 28, 29, 35, 36, and 80; C.I. Pigment Yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157; C.I. Pigment Violet 1, 3, 19, 23, 50, 14, and 16; C.I. Pigment Orange 5, 13, 16, 36, 43, 20, 20:1, and 104; and C.I. Pigment Brown 25, 7, 11, and 33. These pigments can be used alone or in combination of two or more thereof.

Examples of dyes include azo dyes, anthraquinone dyes, condensed polycyclic aromatic carbonyl dyes, indigoid dyes, carbonium dyes, phthalocyanine dyes, methine dyes, and polymethine dyes. Specific examples of dyes include C.I. Direct Red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Acid Red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C. I. Reactive Red 3, 13, 17, 19, 21, 22, 23, 24, 29, 35, 37, 40, 41, 43, 45, 49, and 55; C. I. Basic Red 12, 13, 14, 15, 18, 22, 23, 24, 25, 27, 29, 35, 36, 38, 39, 45, and 46; C. I. Direct Violet 7, 9, 47, 48, 51, 66, 90, 93, 94, 95, 98, 100, and 101; C. I. Acid Violet 5, 9, 11, 34, 43, 47, 48, 51, 75, 90, 103, and 126; C. I. Reactive Violet 1, 3, 4, 5, 6, 7, 8, 9, 16, 17, 22, 23, 24, 26, 27, 33, and 34; C. I. Basic Violet 1, 2, 3, 7, 10, 15, 16, 20, 21, 25, 27, 28, 35, 37, 39, 40, and 48; C. I. Direct Yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C. I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C. I. Reactive Yellow 2, 3, 13, 14, 15, 17, 18, 23, 24, 25, 26, 27, 29, 35, 37, 41, and 42; C. I. Basic Yellow 1, 2, 4, 11, 13, 14, 15, 19, 21, 23, 24, 25, 28, 29, 32, 36, 39, and 40; C. I. Acid Green 16; C. I. Acid Blue 9, 45, 80, 83, 90, and 185; and C. I. Basic Orange 21 and 23. These dyes can be used alone or in combination of two or more thereof.

The content of the coloring agent in the coating film 80 is not particularly limited as long as the coating film 80 does not cause curing failure.

When both the first layers 81a and the second layers 81b contain coloring agents, the color of the coloring agent contained in the first layer 81a is preferably different from the color of the coloring agent contained in the second layers 81b. Thus, the difference in color between the first layers 81a and the second layers 81b can be easily adjusted by adjusting the type of the coloring agent.

Here, the first layers 81a serving as the surface layer of the coating film 80 is opaque. That is, when the surface layer of the coating film 80 is viewed in the direction opposite to the ejection direction DJ, the second layers 81b which are the inner layers of the coating film 80 cannot be seen through the first layers 81a. Alternatively, the second layers 81b which are the inner layers of the coating film 80 may be colorless and transparent. In this case, since the life prediction is performed by determining whether or not the second layers 81b are exposed from the difference between the color of the first layers 81a which are the surface layer of the coating film 80 and the color of the ejection surface F, it is necessary that the color of the ejection surface F and the color of the first layers 81a which are the surface layer of the coating film 80 are different.

The components of the first layers 81a excluding the coloring agent and the components of the second layers 81b excluding the coloring agent are preferably the same. Thereby, the difference in the coefficient of linear expansion between the first layers 81a and the second layers 81b can be substantially eliminated. Therefore, peeling of the coating film 80 due to the difference in the coefficient of linear expansion can be reduced. As the difference in the coefficient of linear expansion increases, the difference in stress between the first layers 81a and the second layers 81b increases when a temperature change occurs, and thus the coating film 80 is easily peeled off. For the same reason, the coefficient of linear expansion of the first layers 81a and the coefficient of linear expansion of the second layers 81b are preferably equal to each other.

The coloring agent is preferably a dye. Accordingly, since the particles of dyes are smaller than those of pigments, it is possible to reduce the degree of adverse effects such as damage to the wiping member 71, damage to the nozzle plates 18c due to the particles adhering to the nozzle plates 18c being rubbed by the wiping member 71, and the occurrence of ejection failures due to particles accumulating in the nozzles. In addition, since the particles of coloring agents are small, there is also an advantage that the coating film 80 can be easily made thin. The coloring agent is not limited to a dye and may be a pigment.

At least one of the set of second layers 81b and the set of first layers 81a may contain, as a coloring agent, a fluorescent material that emits light when irradiated with ultraviolet light. In this case, one or both of the set of first layers 81a and the set of second layers 81b can be made to emit light by irradiating the coating film 80 with ultraviolet light. In this state, the difference between the color of the first layers 81a and the color of the second layers 81b can be recognized based on the presence or absence of light emission or the difference in emission color between the first layers 81a and the second layers 81b.

Examples of the fluorescent material include fluorescent pigments or fluorescent dyes, specifically, C. I. Disperse Red 364, C. I. Disperse Red 362, C. I. Vat Red 41, C. I. Disperse Yellow 232, C. I. Disperse Yellow 184, C. I. Disperse Yellow 82, and C.I. Disperse Yellow 43.

In the region of the coating film 80, described above, overlapping each second layer 81b in the ejection direction DJ, the distance D1 in the ejection direction DJ from the surface Fa of the coating film 80 facing the ejection direction DJ to the boundary surface BD is preferably smaller than the distance D2 in the ejection direction DJ from the boundary surface BD to the ejection surface F. Thus, when the coating film 80 is scraped to the boundary surface BD, half or more of the entire thickness of the coating film 80 remains. Therefore, it is possible to detect the possibility of occurrence of a failure at an early stage before the coating film 80 is entirely peeled off and a failure occurs.

The distance D2 from the boundary surface BD to the ejection surface F in the ejection direction DJ may be two times or more or three times or more the distance D1 from the surface Fa of the coating film 80 facing the ejection direction DJ to the boundary surface BD in the ejection direction DJ. The distance D1 in the ejection direction DJ from the surface Fa of the coating film 80 facing in the ejection direction DJ to the boundary surface BD may be larger than the distance D2 in the ejection direction DJ from the boundary surface BD to the ejection surface F. In this case, the coating film 80 can be used to the maximum.

As illustrated in FIG. 4, the ejection surface F includes nozzle formation regions RN in which a plurality of nozzles N are formed. The nozzle formation regions RN are regions on the nozzle plates 18c, and each nozzle formation region RN is a minimum quadrangular region including the nozzle row La or Lb. Therefore, the nozzle formation regions RN do not exist on the fixing plate 55.

Here, the second layers 81b are disposed outside the nozzle formation regions RN. In the case where the second layers 81b are present around the openings of the nozzles N when viewed in the direction opposite to the ejection direction DJ, the thickness of the coating film 80 increases by the thickness of the second layers 81b, increasing the distance in the ejection direction DJ to the openings of the nozzles N, so that there is a possibility that the discharge characteristics may be adversely affected. However, since the second layers 81b are disposed outside the nozzle formation regions RN, the second layers 81b are disposed away from the nozzles N, and such adverse effects can be prevented. In addition, in a case where the second layers 81b do not have liquid repellency, when liquid repellency is lost in the vicinity of the nozzles N, failures such as flight deviation of ink or color mixing are likely to occur. Therefore, from the viewpoint of suppressing such failures, it is preferable that the second layers 81b are disposed outside of the nozzle formation regions RN. Further, it is preferable that the second layers 81b are provided in regions aligned with each nozzle formation region RN in the direction in which the wiping member 71 wipes the nozzle formation regions RN. In the present embodiment, since the wiping direction of the wiping member 71 is the Y2 direction, it is preferable that the second layers 81b are provided in regions aligned with each nozzle formation region RN in the Y2 direction. Accordingly, in a case where the ink ejected from the nozzles includes a pigment, the coating film 80 is likely to be scraped in regions aligned with the nozzle formation regions RN in the direction in which the wiping member 71 wipes the nozzle formation regions RN because ink containing the pigment is rubbed by the wiping member.

As described above, in the present embodiment, the second layers 81b do not exist on the fixing plate 55, and are provided only on the nozzle plates 18c. Accordingly, since it is possible to detect the degree of deterioration of the coating films 81 provided on the nozzle plates 18c, it is possible to suitably suppress an adverse effect on the discharge characteristics due to the scraping of the coating films 81. In addition, since only the nozzle plates 18c are processed to form the coating film 80, the manufacturing is facilitated.

In addition, the arrangement of the second layers 81b is not limited to the example illustrated in FIG. 4, and for example, the second layers 81b may be on the fixing plate 55 as in an eighth embodiment which will be described later, or may be between the nozzle row La and the nozzle row Lb.

FIG. 7 is an explanatory view of an exposed state of a second layer 81b of the coating film 81. As illustrated in FIG. 7, when the coating film 81 is scraped to the boundary surface BD between the first layer 81a and the second layer 81b, the second layer 81b becomes visible in the scraped portion. Therefore, it is possible to detect that the coating film 81 has been scraped to the boundary between the first layer 81a and the second layer 81b, visually or by using the detection unit 74. Therefore, it is possible to detect a near-failure state of the coating film 81 before a failure occurs in the liquid ejecting head 50 due to all of the coating film 81 being scraped. That is, the life of the coating film 81 can be predicted.

When the life of the coating film 80 can be predicted in this manner, the liquid ejecting head 50 can be replaced at an appropriate time so that a failure does not occur during use. Therefore, it is possible to suppress the occurrence of problems such as downtime for preparing a liquid ejecting head 50 for replacement or wasteful consumption of ink or media.

### 2. Second Embodiment

Hereinafter, a second embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

A coating film 81A has the same configuration as the coating film 81 of the first embodiment except that the coating film 81A additionally includes a third layer 81c.

The third layer 81c is disposed between a second layer 81b and the ejection surface F, and has the same configuration as the second layer 81b except that the third layer 81c has a different color from the colors of a first layer 81a and the second layer 81b.

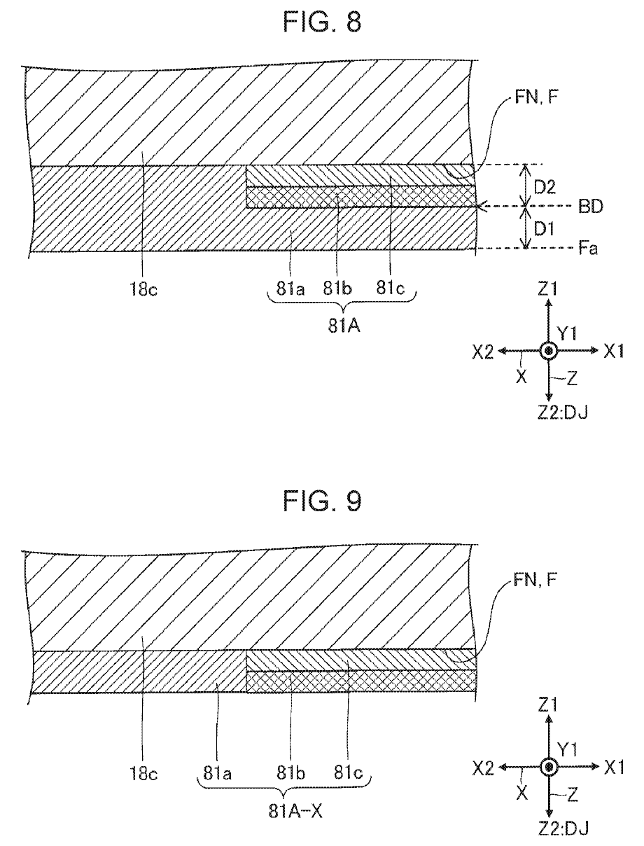

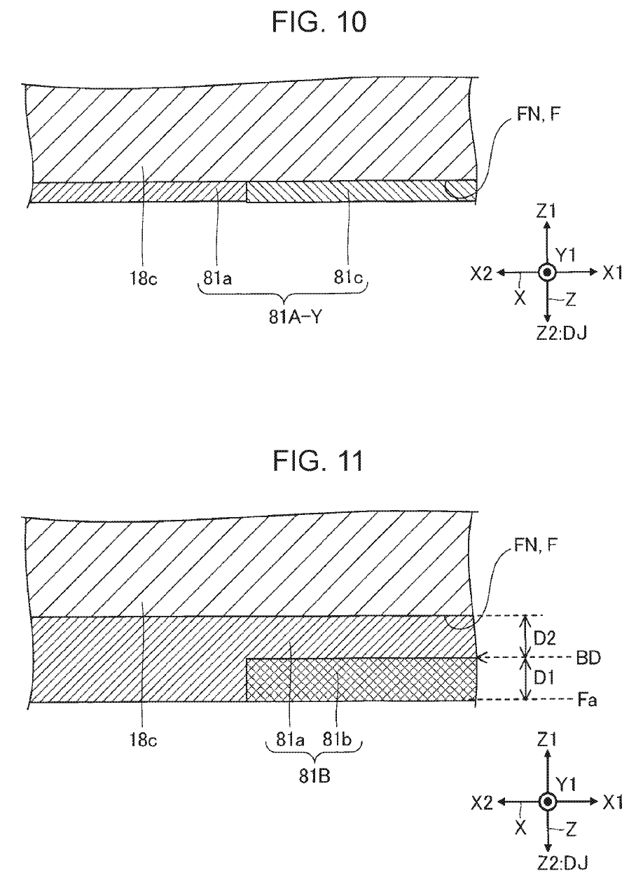

FIG. 8 is a schematic cross-sectional view of the coating film 81A in the second embodiment. FIG. 9 is an explanatory view of an exposed state of the second layer 81b of the coating film 81A. FIG. 10 is an explanatory view of an exposed state of the third layer 81c of the coating film 81A.

In the present embodiment, as illustrated in FIG. 9, as in the first embodiment, not only in the case where the coating film 81A is scraped to the boundary between the first layer 81a and the second layer 81b, but also in the case where the coating film 81A is scraped to the boundary between the second layer 81b and the third layer 81c, as illustrated in FIG. 10, the third layer 81c becomes visible in the scraped portion. Therefore, it is possible to detect that the coating film 81A is scraped to the boundary between the second layer 81b and the third layer 81c. In this way, it is possible to detect near-failure states of the coating film 81A in stages before a failure occurs in the liquid ejecting head 50 due to the entire coating film 81A being scraped. That is, the life of the coating film 81A can be predicted in stages.

### 3. Third Embodiment

Hereinafter, a third embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

FIG. 11 is a schematic cross-sectional view of a coating film 81B in the third embodiment. The coating film 81B has the same configuration as the coating film 81 of the first embodiment except that the stacking order of a first layer 81a and a second layer 81b is opposite to that of the first embodiment.

In the coating film 81B mentioned above, when the coating film 81B is scraped to the boundary between the first layer 81a and the second layer 81b, the second layer 81b disappears in the scraped portion. Thus, it is possible to detect that the coating film 81B has been scraped to the boundary between the first layer 81a and the second layer 81b. Therefore, it is possible to detect a near-failure state of the coating film 81B before a failure occurs in the liquid ejecting head 50 due to the entire coating film 81B being scraped. That is, the life of the coating film 81B can be predicted.

### 4. Fourth Embodiment

Hereinafter, a fourth embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

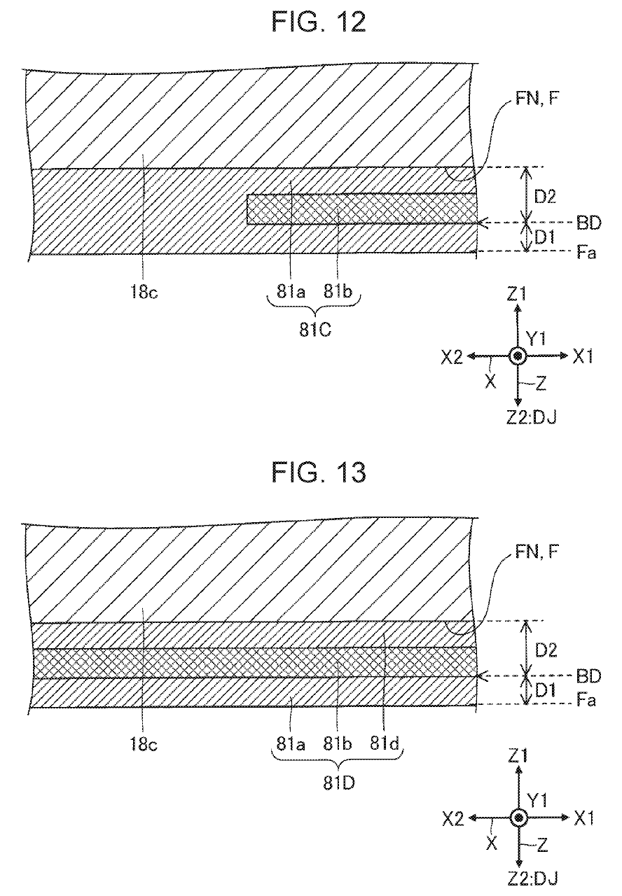

FIG. 12 is a schematic cross-sectional view of a coating film 81C in the fourth embodiment. The coating film 81C has the same configuration as the coating film 81 of the first embodiment except that a second layer 81b is disposed in an intermediate region of a first layer 81a in the thickness direction.

Also with the coating film 81C mentioned above, as in the first embodiment, in a case where the coating film 81C is scraped to the boundary between the first layer 81a and the second layer 81b, the second layer 81b becomes visible in the scraped portion. Thus, it is possible to detect that the coating film 81C has been scraped to the boundary between the first layer 81a and the second layer 81b. Therefore, it is possible to detect a near-failure state of the coating film 81C before a failure occurs in the liquid ejecting head 50 due to the entire coating film 81C being scraped. That is, the life of the coating film 81C can be predicted.

In addition, since the second layer 81b is disposed in an intermediate region of the first layer 81a in the thickness direction, even if the second layer 81b is completely scraped, the liquid repellency by the first layer 81a can be exhibited.

### 5. Fifth Embodiment

Hereinafter, a fifth embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

FIG. 13 is a schematic cross-sectional view of a coating film 81D in the fifth embodiment. The coating film 81D has the same configuration as the first embodiment except that a third layer 81d is provided between a first layer 81a and a second layer 81b, and the first layer 81a, the second layer 81b, and the third layer 81d are provided over the entire region of the ejection surface F. In other words, in the case of a configuration without the fixing plate 55, the first layer 81a, the second layer 81b, and the third layer 81d are provided on the entire surfaces of the nozzle surfaces FN of the nozzle plates 18c, and in the case of a configuration including the fixing plate 55, the first layer 81a, the second layer 81b, and the third layer 81d are provided on the entire surfaces of the nozzle surfaces FN of the nozzle plates 18c and the entire surface FF of the fixing plate 55 facing the Z2 direction.

Here, similar to the third layer 81c of the second embodiment, the third layer 81d preferably has a color different from those of the first layer 81a and the second layer 81b. Thus, as in the second embodiment, the life of the coating film 81D can be predicted in stages.

Further, it is preferable that the third layer 81d has liquid repellency as with the first layer 81a. Thus, as in the fourth embodiment, when the second layer 81b is completely scraped, the liquid repellency can be exhibited by the third layer 81d.

As described above, since the second layer 81b is provided over the entire surface of the ejection surface F, it is possible to detect the life of the coating film 81D wherever an abnormality occurs on the ejection surface F. In addition, in a case where the second layer 81b is provided on the entire surfaces of the nozzle surfaces FN of the nozzle plates 18c and the surface FF of the fixing plate 55 facing the Z2 direction, it is possible to detect the abnormality of the coating film 81D in both of the fixing plate 55 which is likely to be scraped due to strong contact with the wiping member 71 and the nozzle plates 18c which have a significant direct influence on ejection.

In a case where the second layer 81b is provided on the entire surfaces of the nozzle surfaces FN of the nozzle plates 18c and the surface FF of the fixing plate 55 facing the Z2 direction, the second layer 81b needs to have liquid repellency. This allows the second layer 81b to exhibit liquid repellency in a state where the second layer 81b is exposed.

Also in the fifth embodiment described above, the life of the coating film 81D can be predicted.

### 6. Sixth Embodiment

Hereinafter, a sixth embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

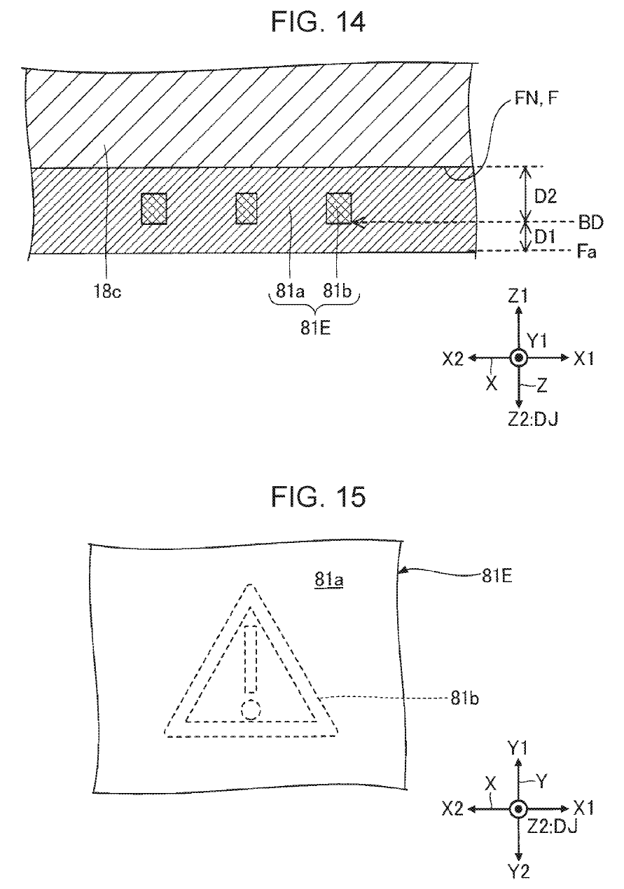

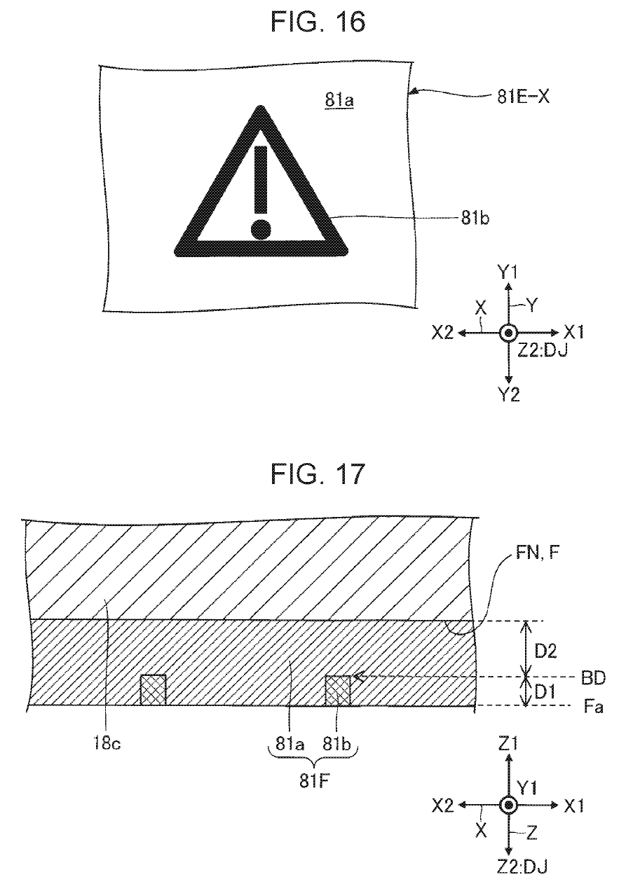

FIG. 14 is a schematic cross-sectional view of a coating film 81E in the sixth embodiment. FIG. 15 is a plan view illustrating a state where a second layer 81b is covered with a first layer 81a in the coating film 81E illustrated in FIG. 14. FIG. 16 is a plan view of a state where the second layer 81b is exposed from the first layer 81a in the coating film 81E illustrated in FIG. 14. In FIG. 15, for convenience of description, the shape of the second layer 81b is indicated by broken lines, but in practice, the second layer 81b is not visible in a state where the second layer 81b is covered with the first layer 81a.

The coating film 81E has the same configuration as the coating film 81C of the fourth embodiment except that the shape of the second layer 81b when viewed in the direction along the Z-axis is different.

In the present embodiment, the second layer 81b serves as an indicator for indicating the replacement time of the liquid ejecting head 50 when viewed in the direction opposite to the ejection direction DJ. Accordingly, in a case where the second layer 81b is initially covered with the first layer 81a as in the present embodiment, when text or an indicator formed by the second layer 81b is seen, the user easily detects that the coating film 81E is nearing the end of its life. Note that the indicator formed by the second layer 81b is not limited to the example shown in the figure, and may be selected as appropriate. In addition, the second layer 81b may form text for indicating the replacement time of the liquid ejecting head 50.

Also in the sixth embodiment, the life of the coating film 81E can be predicted.

### 7. Seventh Embodiment

Hereinafter, a seventh embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

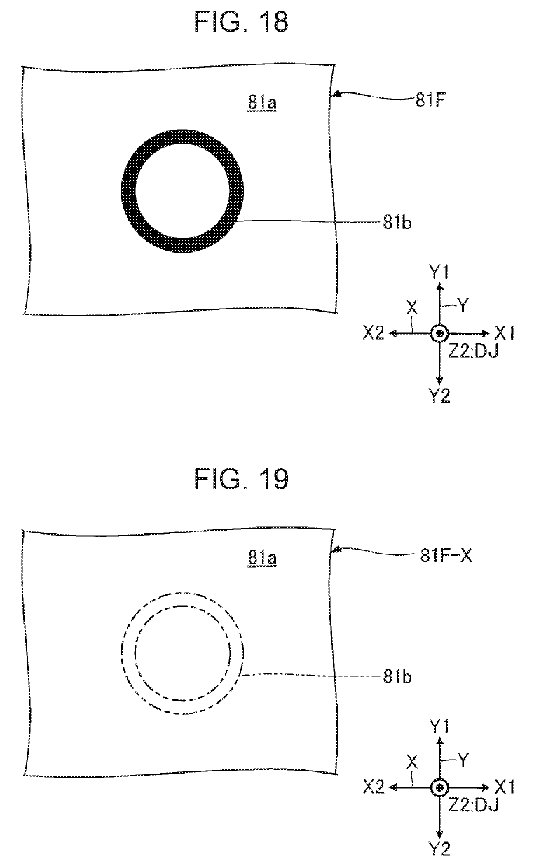

FIG. 17 is a schematic cross-sectional view of a coating film 81F in the seventh embodiment. FIG. 18 is a plan view of a state where a second layer 81b remains in the coating film 81F illustrated in FIG. 17. FIG. 19 is a plan view of a state where the second layer 81b has disappeared in the coating film 81F illustrated in FIG. 17. In FIG. 19, for convenience of description, the shape of the second layer 81b is indicated by dashed double-dotted lines, but in practice, the second layer 81b is not seen in a state where the second layer 81b has disappeared.

The coating film 81F has the same configuration as the coating film 81B of the third embodiment except that the shape of the second layer 81b when viewed in the direction along the Z-axis is different.

In the present embodiment, the second layer 81b serves as an indicator for indicating the replacement time of the liquid ejecting head 50 when viewed in the direction opposite to the ejection direction DJ. Thus, in the case where the second layer 81b is initially exposed as in the present embodiment, the user can detect that the life of the coating film 81F is nearing its end when the text or the indicator disappears. Note that the indicator formed by the second layer 81b is not limited to the example shown in the figure, and may be selected as appropriate. In addition, the second layer 81b may form text for indicating the replacement time of the liquid ejecting head 50.

Also in the seventh embodiment, the life of the coating film 81F can be predicted.

### 8. Eighth Embodiment

Hereinafter, an eighth embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

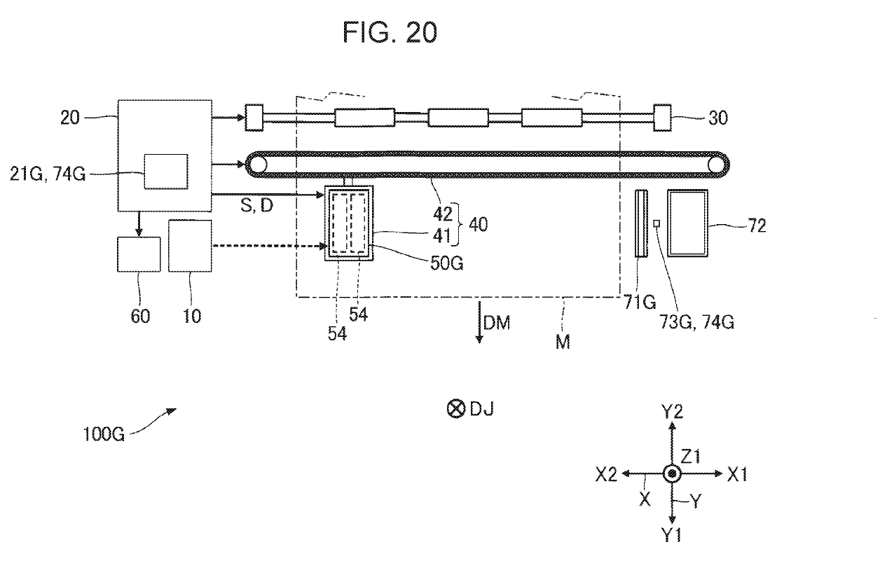

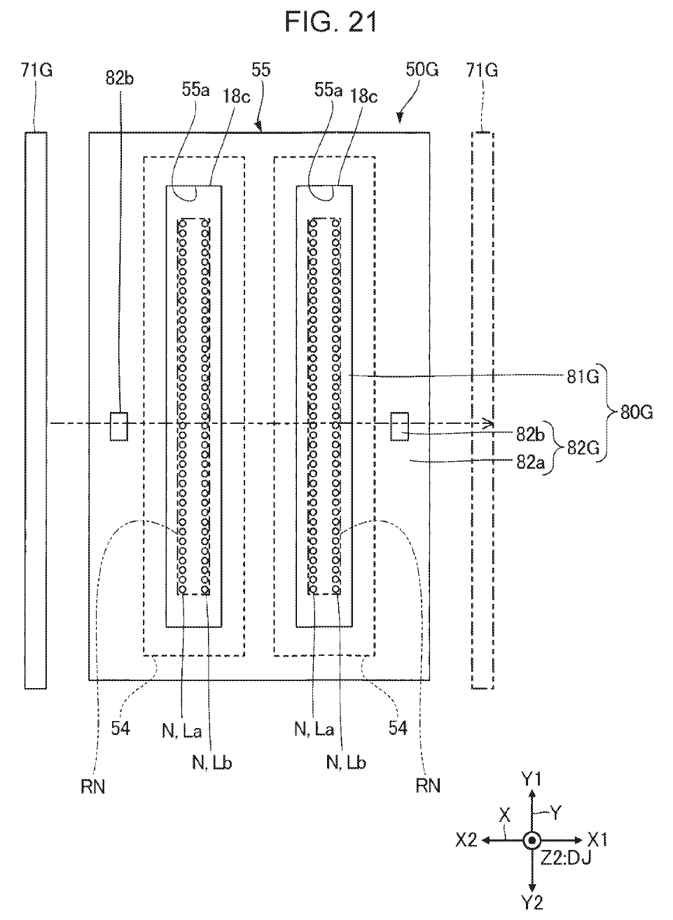

FIG. 20 is a schematic view illustrating a configuration example of a liquid ejecting apparatus 100G according to the eighth embodiment. FIG. 21 is a bottom view of a liquid ejecting head 50G according to the eighth embodiment. The liquid ejecting apparatus 100G has the same configuration as the liquid ejecting apparatus 100 of the first embodiment except that the liquid ejecting apparatus 100G includes the liquid ejecting head 50G instead of the liquid ejecting head 50 of the first embodiment, a sensor 73G instead of the sensors 73 of the first embodiment, and a wiping member 71G instead of the wiping member 71 of the first embodiment.

The wiping member 71G is an elastic member such as a blade-shaped rubber member formed of an elastic material such as rubber, having an elongated shape extending in the direction along the Y-axis, and protruding in the Z1 direction. The wiping member 71G is disposed at a position away from the transport region of the medium M in the direction along the X-axis. When the wiping member 71G wipes the nozzle plates 18c or the fixing plate 55, the movement mechanism 40 moves the liquid ejecting head 50 to a position overlapping the wiping member 71G when viewed in the direction along the Z-axis, as illustrated in FIG. 21. In this state, wiping or cleaning is performed by wiping the nozzle plates 18c and the fixing plate 55 with the wiping member 71.

The liquid ejecting head 50G has the same configuration as the liquid ejecting head 50 of the first embodiment except that the liquid ejecting head 50G includes a coating film 80G instead of the coating film 80. The coating film 80G is divided into coating films 81G and a coating film 82G. The coating films 81G have the same configuration as the coating films 81 of the first embodiment except that the second layers 81b are omitted.

The coating film 82G has the same layer configuration as the coating film 81 of the first embodiment, and includes a first layer 82a and second layers 82b. The first layer 82a has the same configuration as the first layers 81a of the first embodiment except that the first layer 82a is provided on the fixing plate 55. The second layers 82b have the same configuration as the second layers 81b of the first embodiment except that the second layers 82b are provided on the fixing plate 55.

As described above, in the present embodiment, the second layers 82b are not provided on the nozzle plates 18c, but are provided on the fixing plate 55. Here, the second layers 82b is aligned with the nozzle formation regions RN in the direction along the X-axis.

The sensor 73G has the same configuration as the sensors 73 of the first embodiment except that the sensor 73G includes one sensor that corresponds to the positions of the second layers 82b. Here, the sensor 73G and the determination unit 21 constitute a detection unit 74G that detects whether or not a second layer 82b is exposed.

Since the coating film 82G of the fixing plate 55 comes into contact with the wiping member 71G more strongly than the nozzle plates 18c, the coating film 82G of the fixing plate 55 is more likely to be rubbed than the coating films 81G of the nozzle plates 18c. To address the above situation, in the present embodiment, by providing the second layers 82b on the fixing plate 55, it is possible to predict the life before liquid repellency in the vicinity of the nozzles N is lost and failures such as flight deviation of ink or color mixing occur.

Further, in the present embodiment, since it is not necessary to provide the second layers 81b on the nozzle plates 18c, manufacturing is facilitated.

Also in the eighth embodiment, the life of the coating film 82G can be predicted.

### 9. Modification Examples

The embodiments illustrated above may be modified in various ways. Specific aspects of modifications that can be applied to the above embodiments will be illustrated below as examples. Any two or more aspects selected from the following examples as appropriate can be appropriately combined within a range in which they do not contradict each other.

### 9-1. Modification 1

In the above-described embodiments, an aspect in which the liquid ejecting head includes two head chips is illustrated as an example, but the present disclosure is not limited to this aspect. The number of head chips included in the liquid ejecting head may be one, or three or more. In addition, in a case where the liquid ejecting head includes a plurality of head chips, the arrangement of the plurality of head chips is not limited to the above-described embodiments and may be in any suitable configuration. In addition, the shape of the liquid ejecting head is also not limited to the above-described embodiments and may be in any suitable configuration.

### 9-2. Modification 2

In the above-described embodiments, the liquid ejecting apparatus 100 of a serial type in which the transport member 41 on which the liquid ejecting head 50 is mounted reciprocates in the width direction of the medium M is illustrated as an example, but the liquid ejecting apparatus may be of a line type in which a plurality of nozzles N are distributed across the entire width of the medium M.

### 9-3. Modification 3

The liquid ejecting apparatus illustrated in the above embodiments can be employed in various apparatuses such as facsimile apparatuses and copy machines, in addition to apparatuses dedicated to printing. As a matter of course, applications of the liquid ejecting apparatus are not limited to printing. For example, a liquid ejecting apparatus that ejects a solution of a coloring material is used as a manufacturing apparatus that forms a color filter of a display device such as a liquid crystal display panel. A liquid ejecting apparatus that ejects a solution of a conductive material is used as a manufacturing apparatus that forms wiring or electrodes on a wiring substrate. A liquid ejecting apparatus that ejects a solution of an organic material related to a living body is used as, for example, a manufacturing apparatus that manufactures a biochip.

### 10. Appendices

The present disclosure is summarized as follows.

Appendix 1: A first aspect which is a preferred example of a liquid ejecting head of the present disclosure is a liquid ejecting head including: a plurality of nozzles configured to eject liquid in an ejection direction; an ejection surface that is a surface facing the ejection direction; and a coating film provided on the ejection surface, in which the coating film includes a first layer having higher liquid repellency than the ejection surface and a second layer having a color different from a color of the first layer, and the second layer overlaps at least part of the first layer when viewed in a direction opposite to the ejection direction.

In the above aspect, when the coating film has been scraped to the boundary between the first layer and the second layer, the second layer becomes visible or the second layer disappears in the scraped portion. Therefore, it is possible to detect that the coating film has been scraped to the boundary between the first layer and the second layer. Therefore, it is possible to detect a near-failure state of the coating film before a failure occurs in the liquid ejecting head due to the entire coating film being scraped. That is, the life of the coating film can be predicted.

Appendix 2: In a second aspect which is a preferred example of the first aspect, the second layer has higher liquid repellency than the ejection surface. In the above aspect, it is possible to prevent the liquid from adhering to the second layer in a state where the second layer is exposed.

Appendix 3: In a third aspect which is a preferred example of the first aspect or the second aspect, the second layer serves as text or an indicator for indicating a replacement time of the liquid ejecting head when viewed in the direction opposite to the ejection direction. In the above aspect, in a case where the second layer is covered with the first layer, when the text or the indicator is seen, it is easy for the user to detect that the coating film is nearing the end of its life. In a case where the second layer is initially exposed, the user can detect that the coating film is nearing the end of its life when the text or the indicator disappears.

Appendix 4: In a fourth aspect which is a preferred example of any one of the first aspect to the third aspect, the coating film has a boundary surface that is one of the boundary surfaces between the first layer and the second layer and that is substantially parallel to the ejection surface and located farthest in the ejection direction among the boundary surfaces between the first layer and the second layer, and in a region of the coating film overlapping the second layer in the ejection direction, a distance in the ejection direction from a surface of the coating film facing the ejection direction to the boundary surface is smaller than a distance in the ejection direction from the boundary surface to the ejection surface. In the above aspect, when the coating film is scraped to the boundary surface, half or more of the thickness of the entire coating film remains. Therefore, it is possible to detect the possibility of occurrence of a failure at an early stage before the coating film is entirely peeled off and a failure occurs.

Appendix 5: In a fifth aspect which is a preferred example of any one of the first aspect to the fourth aspect, at least one of the first layer and the second layer contains a coloring agent. In the above aspect, the difference in color between the first layer and the second layer can be easily adjusted by adjusting the type, presence or absence, content, or the like of the coloring agent.

Appendix 6: In a sixth aspect which is a preferred example of the fifth aspect, each of the first layer and the second layer contains a coloring agent, and a color of the coloring agent contained in the first layer is different from a color of the coloring agent contained in the second layer. In the above aspect, the difference in color between the first layer and the second layer can be easily adjusted by adjusting the type of the coloring agent.

Appendix 7: In a seventh aspect which is a preferred example of the fifth aspect, the coloring agent is a dye. In the above aspect, since the particles of dyes are smaller than the particles of pigments, it is possible to reduce the degree of adverse effects such as damage to the wiping member, damage to the nozzle plate due to the particles placed on the nozzle plate being rubbed by the wiping member, and the occurrence of ejection failures due to the particles accumulating in the nozzles. In addition, since the particles of coloring agents are small, there is also an advantage that the coating film can be easily made thin.

Appendix 8: In an eighth aspect which is a preferred example of the fifth aspect, a component of the first layer excluding the coloring agent and a component of the second layer excluding the coloring agent are the same as each other. In the above aspect, the difference in the coefficient of linear expansion between the first layer and the second layer can be substantially eliminated. Therefore, peeling of the coating film due to the difference in the coefficient of linear expansion can be reduced. As the difference in the coefficient of linear expansion increases, the difference in the amount of shrinkage between the first layer and the second layer due to curing also increases. Therefore, the coating film is easily peeled off due to the difference in stress between the first layer and the second layer.

Appendix 9: In a ninth aspect which is a preferred example of any one of the first aspect to the eighth aspect, the liquid ejecting head further includes a nozzle plate including at least part of the ejection surface and having the plurality of nozzles, the ejection surface includes a nozzle formation region in which the plurality of nozzles are formed, and the second layer is disposed outside the nozzle formation region. In the above aspect, if the second layer is present around the nozzle openings when viewed in the direction opposite to the ejection direction, the distance in the ejection direction to the openings from which ink is ejected is increased due to an increase in the thickness of the coating film, which may adversely affect the ejection characteristics. However, since the second layer is disposed outside the nozzle formation region, and hence the second layer is away from the nozzles, such an adversely effect can be reduced. In addition, in a case where the second layer does not have liquid repellency, when the liquid repellency is lost in the vicinity of the nozzles, failures such as flight deviation of ink or color mixing are likely to occur. Therefore, from the viewpoint of suppressing such failures, it is preferable that the second layer is disposed outside the nozzle formation region.

Appendix 10: In a tenth aspect which is a preferred example of any one of the first aspect to the ninth aspect, the liquid ejecting head further includes a fixing plate having an opening for exposing the plurality of nozzles and at least part of the ejection surface, and the second layer is provided on the fixing plate. In the above aspect, since the wiping member comes into contact with the coating film of the fixing plate with a larger force than with the nozzle plate, the coating film of the fixing plate is more likely to be rubbed than the coating film of the nozzle plate. To address this, the second layer is provided on the fixing plate. Thus, it is possible to predict the life before the liquid repellency in the vicinity of the nozzles is lost and failures such as flight deviation of ink or color mixing occur.

Appendix 11: In an eleventh aspect which is a preferred example of the tenth aspect, the liquid ejecting head further includes a nozzle plate having the plurality of nozzles, and the second layer is not provided on the nozzle plate. In the above aspect, since it is not necessary to form the second layer on the nozzle plate, the manufacturing is facilitated.

Appendix 12: In a twelfth aspect which is a preferred example of any one of the first aspect to the eleventh aspect, the second layer is provided over an entire surface of the ejection surface. In the above aspect, the life of the coating film can be detected wherever an abnormality occurs on the ejection surface. In addition, it is possible to detect the abnormality of the coating film in both the fixing plate which is likely to be scraped due to strong contact with the wiping member and the nozzle plate which has a significant direct influence on the ejection.

Appendix 13: A thirteenth aspect which is a preferred example of the liquid ejecting apparatus according to the present disclosure includes: the liquid ejecting head according to any one of the first to twelfth aspects; and a detection unit that detects whether or not the second layer is exposed.

In the above aspect, the presence or absence of the exposure of the second layer can be checked by the detection unit. Therefore, the labor for visual checking can be omitted. In addition, the detection accuracy is high because the color difference detection capability or resolution is higher than visual checking. Therefore, the degrees of freedom of the colors of the first layer and the second layer can be increased, and the size of the indicator or the text can be small.

What is claimed is:

1. A liquid ejecting head comprising:
a plurality of nozzles configured to eject liquid in an ejection direction;
an ejection surface that is a surface facing the ejection direction; and
a coating film provided on the ejection surface, wherein
the coating film includes
a first layer having higher liquid repellency than the ejection surface and
a second layer having a color different from a color of the first layer, and
the second layer overlaps at least part of the first layer when viewed in a direction opposite to the ejection direction.

2. The liquid ejecting head according to claim 1, wherein
the second layer has higher liquid repellency than the ejection surface.

3. The liquid ejecting head according to claim 1, wherein
the second layer serves as text or an indicator for indicating a replacement time of the liquid ejecting head when viewed in the direction opposite to the ejection direction.

4. The liquid ejecting head according to claim 1, wherein
the coating film has a boundary surface that is one of the boundary surfaces between the first layer and the second layer and that is substantially parallel to the ejection surface and located farthest in the ejection direction among the boundary surfaces between the first layer and the second layer, and
in a region of the coating film overlapping the second layer in the ejection direction, a distance in the ejection direction from a surface of the coating film facing the ejection direction to the boundary surface is smaller than a distance in the ejection direction from the boundary surface to the ejection surface.

5. The liquid ejecting head according to claim 1, wherein
at least one of the first layer and the second layer contains a coloring agent.

6. The liquid ejecting head according to claim 5, wherein
each of the first layer and the second layer contains a coloring agent, and
a color of the coloring agent contained in the first layer is different from a color of the coloring agent contained in the second layer.

7. The liquid ejecting head according to claim 5, wherein
the coloring agent is a dye.

8. The liquid ejecting head according to claim 5, wherein
a component of the first layer excluding the coloring agent and a component of the second layer excluding the coloring agent are the same as each other.

9. The liquid ejecting head according to claim 1, further comprising
a nozzle plate including at least part of the ejection surface and having the plurality of nozzles, wherein
the ejection surface includes a nozzle formation region in which the plurality of nozzles are formed, and
the second layer is disposed outside the nozzle formation region.

10. The liquid ejecting head according to claim 1, further comprising
a fixing plate having an opening for exposing the plurality of nozzles and at least part of the ejection surface, wherein
the second layer is provided on the fixing plate.

11. The liquid ejecting head according to claim 10, further comprising
a nozzle plate having the plurality of nozzles, wherein
the second layer is not provided on the nozzle plate.

12. The liquid ejecting head according to claim 1, wherein
the second layer is provided over an entire surface of the ejection surface.

13. A liquid ejecting apparatus comprising:
the liquid ejecting head according to claim 1; and
a detection unit that detects whether or not the second layer is exposed.
